(19) United States
(12) Patent Application Publication
(10) Pub. No.: US 2023/0058903 A1
(43) Pub. Date: Feb. 23, 2023

(54) Customer Behavioural System

(71) Applicant: ITAB SHOP PRODUCTS AB, Jönköping (SE)

(72) Inventors: Johan Möller, Huskvarna (SE); Tobias Pettersson, Ulricehamn (SE); Martin Angenfelt, Jönköping (SE)

(21) Appl. No.: 17/794,313

(22) PCT Filed: Jan. 21, 2021
(86) PCT No.: PCT/SE2021/050033

§ 371 Date: Jul. 21, 2022

(30) Foreign Application Priority Data
Jan. 22, 2020 (SE) 2050058-3

(51) Int. Cl. G07G 3/00; G06Q 20/18; G06V 40/20

(52) U.S. Cl. CPC G07G 3/006; G07G 3/003; G06Q 20/18; G06V 40/23

(57) ABSTRACT

A customer behavioural system (100) in a store (10), the customer behavioural system (100) comprising a sensor arrangement (110) comprising one or more sensors (114a-c) and a behavioural analysis module (120). The behavioural analysis module (120) is configured to determine at least one behavioural feature (160) of a customer (20) based on sensor data from said one or more sensors (114a-c) and/or determine at least one motion event (160) of a customer (20) based on sensor data from said one or more sensors (114a-c), and determine behavioural information (122) for said customer (20) based at least on one determined behavioural feature (140) and/or at least one determined motion event (160).

### TECHNICAL FIELD

The present invention relates to customer behavioural system for use in a store and more precisely to a customer behavioural system that take into account different aspects of the customer in order to generate behavioural information of the customer.

### BACKGROUND

In modern stores and retail establishments it is becoming more and more common to use automatic, or semi-automatic, registration and checkout of goods. The typical customer is often requested to scan his merchandise by himself and complete the transaction by paying for the goods at an unmanned register. The scanning of the goods may be done e.g. by means of a handheld scanner during the collection of the goods in the store or at checkout at an unmanned checkout counter.

These unmanned checkout systems are cost and space effective and it is possible to have many more unmanned checkout counters for the same area and operational cost as a manned checkout counter. This saves time for the customer since the queuing for unmanned checkout will typically be shortened due to the higher number of unmanned checkout counters. However, one problem with unmanned checkout systems is the complexity of the systems and that customers may have trouble knowing how and when to make the correct steps. From the above, it is understood that there is room for improvements.

### SUMMARY

An object of the present invention is to provide a new type of customer behavioural system for use in a store which is improved over prior art and which eliminates or at least mitigates the drawbacks discussed above. More specifically, an object of the invention is to provide a customer behavioural system that analyses the behaviour of the customer. This behavioural information can be used to gain statistical data of the customer and/or store, to control guidance event for the customer in question and/or to control guidance events for store personnel in the store. This invention can be used on a checkout system in a store, or on any areas in the store such as, but not limited to, coffee machines, service desks, shelves, produce scales, deli counters, interactive displays, digital signage and click and collect areas. These objects are achieved by the technique set forth in the appended independent claims with preferred embodiments defined in the dependent claims related thereto.

In a first aspect, a customer behavioural system in a store is provided. The customer behavioural system comprises a sensor arrangement comprising one or more sensors, and a behavioural analysis module configured to determine at least one behavioural feature of a customer based on sensor data from said one or more sensors, and/or determine at least one motion event of a customer based on sensor data from said one or more sensors, and determine behavioural information for said customer based at least on one determined behavioural feature and/or at least one determined motion event.

In one embodiment, the behavioural information is at least used to provide guidance events for a customer, provide guidance events for store personnel and/or to provide statistical information to the customer behavioural system.

The behavioural information may at least be used to control at least one output means.

In one embodiment the output means comprises at least one of: a light source, a sound emitter, a display and/or a communication unit.

In one embodiment, the behavioural feature of a customer comprises information of facial expression of the customer, information of audio characteristics of the customer and/or information of movement characteristics of the customer.

The motion event may comprise information of at least one of: movements of the customer, position of the customer, direction of the customer and/or gestures of the customer. In one embodiment said movement, position and/or direction of said customer comprises a movement, position and/or a direction of said customer's head, face, arm(s), hand(s), torso, shoulder(s), neck, elbow(s), leg(s), knee(s), feet, fingers and/or hip(s), wrist and/or nose and/or a gaze direction of the customer.

In one embodiment, the step of determining at least one motion event of a customer at least comprises continuously tracking, by the sensor arrangement, the movement of the customer.

In one embodiment, the step of detecting at least one motion event of a customer at least comprises detecting when an article, to be purchased by the customer, is moved. The step of detecting at least one motion event of a customer may at least comprises detecting the direction of movement of the article.

The sensor arrangement may further be configured to detect at least one customer feature of a customer based on data from said one or more sensors, and wherein the behavioural analysis module is further configured to determine behavioural information for said customer based at least on one behavioural feature of the customer, at least one motion event of the customer and at least one customer feature of a customer. The customer feature may comprise estimated information of at least one of: age of the customer, gender of the customer, clothing of the customer, weight of the customer, facial hair of the customer, skin colour of the customer, the length of the customer, and/or a personal item of the customer.

In one embodiment, the behavioural analysis module is further configured to use machine learning to determine behavioural information of the customer by associating sensor data with previous usage of the system.

In one embodiment, the behavioural analysis module is further configured to use statistical analysis to determine behavioural information of the customer.

In one embodiment, the behavioural analysis module is further configured to use the determined behavioural information to determine if the customer has a deviant behaviour. In one embodiment, if it is determined that a customer has a deviant behaviour, the system may transmit instructions to execute an anti-theft operation. In one embodiment, if it is determined that a customer has a deviant behaviour, the system may provide more guidance to the customer in order for he/she to complete the process.

In one embodiment, the customer behavioural system is arranged to be used in unmanned areas in a store. The unmanned areas could be a checkout station or unmanned drink section in a store.

In one embodiment, the customer behavioural system is arranged to be used in a checkout system, and wherein the checkout system comprises one or more identification means. The identification means may at least one of a barcode reader or a scale.

In a second aspect, a checkout system in a store comprising the customer behavioural system according to the first aspect is provided.

In a third aspect, a customer behavioural method for determining behavioural information of a customer in a store is provided. The customer behavioural method comprises collecting sensor data comprising information relating to at least one motion event of the customer and/or at least one behavioural feature of the customer, determining, based on the collected sensor data, at least one motion event of the customer and/or at least one behavioural feature of the customer, and determining behavioural information of said customer based on the at least one motion event and/or at least one behavioural feature.

The method may further comprise the step of providing an output based on the determined behavioural information. The output may be arranged to provide guidance events for a customer, provide guidance events for store personnel and/or to provide statistical information to the customer behavioural system.

In one embodiment, the steps of determining at least one motion event and/or at least one behavioural feature is performed using post-processing algorithms of the collected sensor data. The post-processing algorithms may be at least one of: machine learning, deep learning, convolutional neural networks, computer vision, human pose estimation, object detection, image classification, action classification and/or optical flow.

### BRIEF DESCRIPTION OF THE DRAWINGS

Embodiments of the invention will be described in the following; references being made to the appended diagrammatical drawings which illustrate non-limiting examples of how the inventive concept can be reduced into practice.

FIG. 1 is a schematic overview of a store.

FIG. 2 is a schematic block diagram of a customer behavioural system.

FIGS. 3a-c are schematic views of parts of the customer behavioural system.

FIG. 4 is a schematic block diagram of a customer behavioural system.

FIG. 5 is a schematic block diagram is a schematic block diagram of a customer behavioural system in the form of a checkout system.

FIGS. 6a-c are simplified schematic flow charts of a customer behavioural methods.

### DETAILED DESCRIPTION OF EMBODIMENTS

Hereinafter, certain embodiments will be described more fully with reference to the accompanying drawings. The invention may, however, be embodied in many different forms and should not be construed as limited to the embodiments set forth herein; rather, these embodiments are provided by way of example so that this disclosure will be thorough and complete, and will fully convey the scope of the invention, such as it is defined in the appended claims, to those skilled in the art.

Throughout this disclosure terms such as self-checkout, automatic checkout and unmanned checkout are used interchangeably and should be interpreted as referencing the same thing unless otherwise stated. In addition, the term checkout system is to be understood as comprising all types of checkout systems e.g. manual and automatic checkout systems. Articles for purchase in a store are referenced to as goods, articles and/or items and these words are to be interpreted as meaning the same thing.

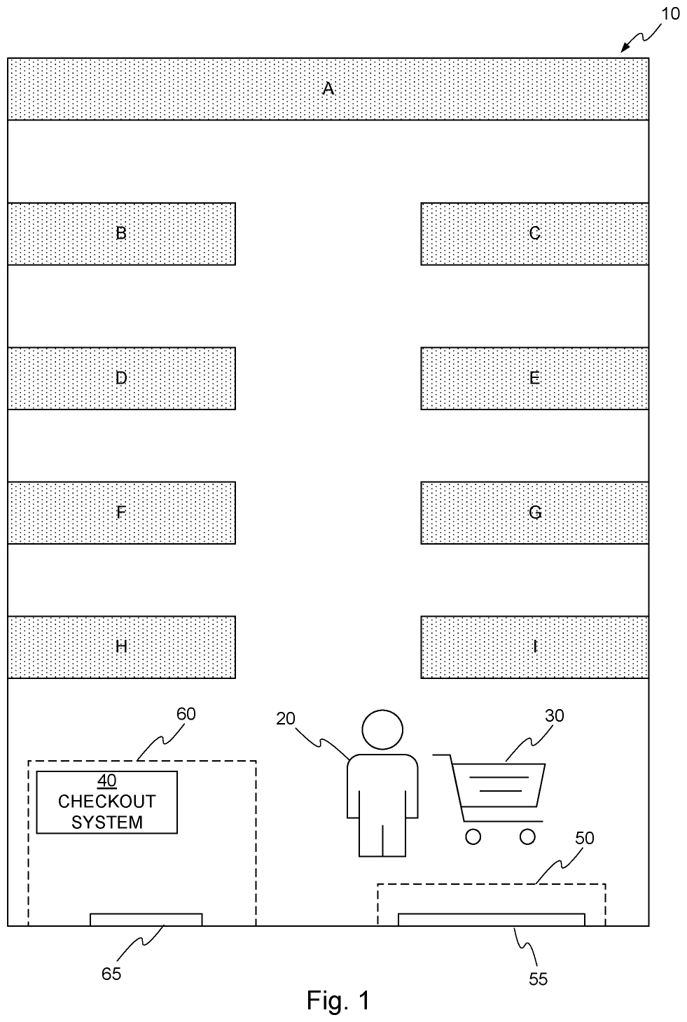

With reference to FIG. 1, a brief introduction to a typical store 10 will be given. The store 10 may comprise a plurality of article containing areas A-I, such as shelves, displaying articles available for purchase. The store may further comprise an entrance area 50 comprising an entrance gate 55 and a checkout area 60 comprising an exit gate 65. The checkout area typically comprises a checkout system 40. The store 10 is arranged such that a customer 20 may freely move around the article containing areas A-I with or without a carrying arrangement 30 such as a shopping cart, a basket, a bag, a backpack or similar.

In prior art systems, many customers will be reluctant to use unmanned areas in a store, such as unmanned checkout stations or unmanned hot drink sections. This reluctance may have many reasons, for example that the process often to take long time as people tend to use it wrongly, as well as the fear of making mistakes or ending up in embarrassing situations where error messages or alerts from the counters are signalled visually and audibly. Further to this, the customers using the unmanned checkout systems and unmanned hot drink sections, and the like, are subjected to manual random checks to see if the customer has correctly transacted his purchase. Customers can, by accident due to incorrect usage of the system, or with ill intent, fail to log or scan one or more goods and consequently steal the un-scanned goods. In addition, customers who are very experienced with unmanned stations can find the unmanned station too slow or too sensitive with an unnecessary amount of prompting for customer information, e.g. number of bags, taking too long to put goods in the bag, being too fast in putting the goods in the bag etc. These and more shortcomings are solved by a customer behavioural system provided herein.

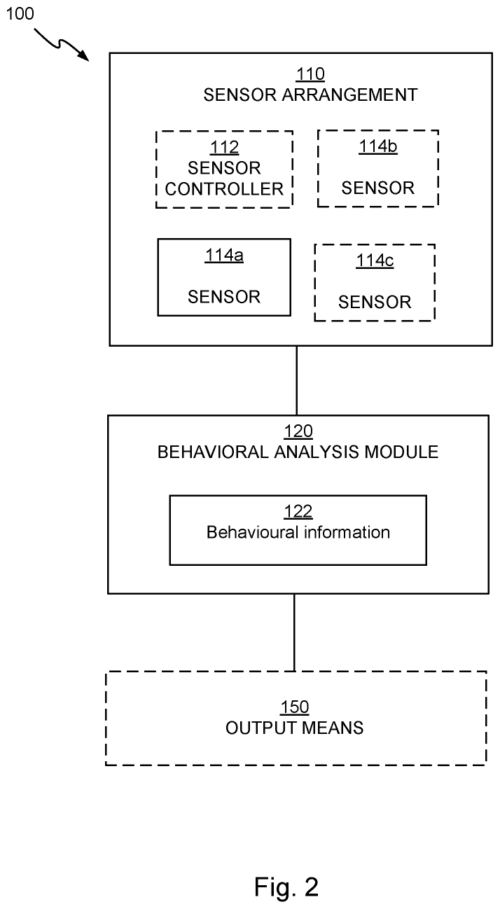

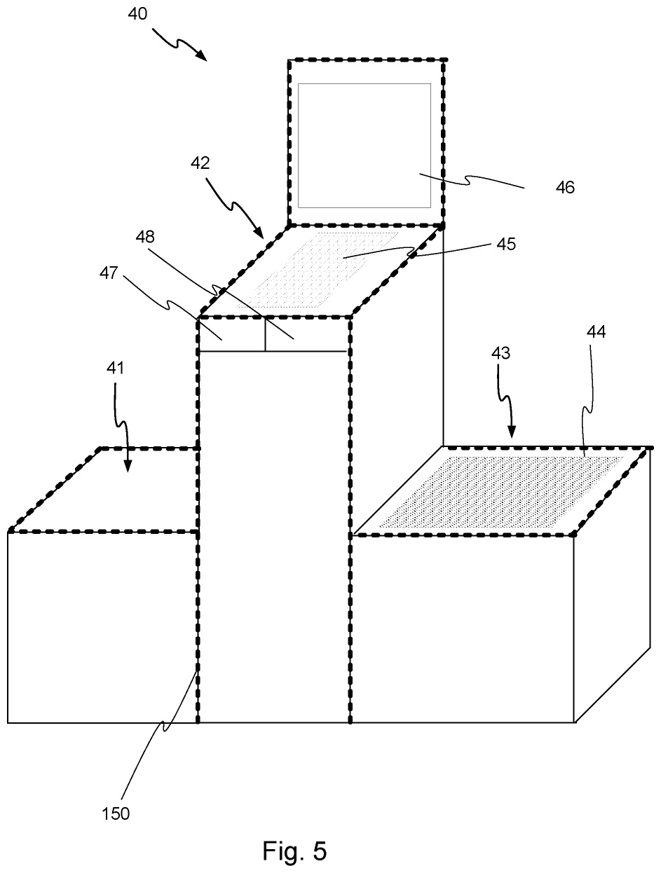

In FIG. 2, a schematic view of a customer behavioural system 100 is presented. The customer behavioural system 100 comprises a sensor arrangement 110 and a behavioural analysis module 120. The system 100 may optionally comprise an output means 150. The output means 150 may comprise a light source, a sound emitter, a display and/or a communication unit and will be described further with reference to FIG. 5.

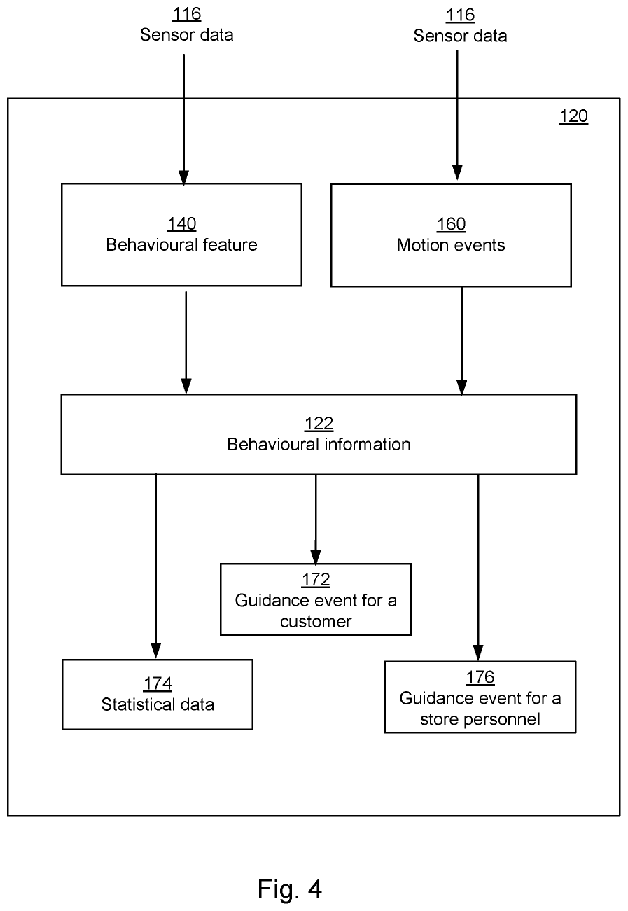

The behavioural analysis module 120 is in operative communication with the sensor arrangement 110 and, if present, the one or more output means 150. Based on the collected sensor data from the sensor arrangement 110, behavioural information is determined by the behavioural analysis module. The behavioural information may be used to provide statistical data, to provide or control guidance event for a customer and/or store personnel, as will be described more in detail with reference to FIG. 4.

Sensor Arrangement

One embodiment of the sensor arrangement 110 of the system 100 is schematically depicted in FIG. 4. As seen in FIG. 2, the sensor arrangement 110 comprises at least one sensor 114a-c but may comprise a plurality of sensors 114a-c The sensors 114a-b may be the same type or different types of sensors.

In one embodiment the sensor arrangement 110 is arranged in the checkout system 40 or is located in association with the checkout system 40. However, it should be noted that the sensor arrangement 100 could be arranged in other locations in the store as well. The sensor arrangement 110 may be a single device located in e.g. association with the checkout system 40 or, in some embodiments, be embodied as a distributed system comprising sensors 114a-c located throughout the store.

The sensor arrangement 110 may comprise any suitable sensor 114a-c or combination of sensors 114a-c arranged such that the sensor arrangement 110 may provide the behavioural analysis module 120 with information regarding different aspects of the customer, as will soon be described more in detail.

Many different types of sensors 114a-c may be utilized, for example one or more of: a camera, a spectroscopy sensor, a RFID sensor, a contour sensor, a weight sensor, a symbol or text recognizing sensor, stereo camera, structured light sensor, event camera, radar, microwave sensor, OCR, 3D-sensor or camera, time of flight sensor, presence sensor, switch sensor, accelerometer, movement sensor, temperature sensor, an object sensor, a light curtain, an IR camera, and a LIDAR sensor. Further embodiments may include sensors 114a-c in the floor, e.g. pressure sensors, configured to detect the presence of a customer 20 and also the direction of the customer based on e.g. a pressure profile.

In one embodiment, one or a plurality of sensors 114a-c may be arranged on an article carrying device 30. If at least one sensor 114a-c is arranged on the article carrying device 30, the sensor 114a-c can be used to continuously generate data and thus generate a map of the customer's 20 movements throughout of the store 10. These sensors may be part of the system 100, but may also be data that is transmitted from another system in the store, such as a tracking system, and can be used by the behavioural analysis module 120.

In one embodiment, the sensor arrangement 110 further comprises an identification means, e.g. a card, tag or barcode reader arranged to identify the customer 20. This may for example be performed by scanning a membership card/tag, driver license or any other type identification associated with the customer 20.

The sensor arrangement 110 may comprise a sensor controller 112 that is in operative communication with, or operatively connected to, the at least one sensor 114a-b. The sensor controller 112 may be any suitable means for controlling and collecting data from the one or more sensors 114. Such means are e.g. processors, MCUs, FPGAs, DSPs. The controller may comprise a volatile memory and may further comprise a non-volatile memory. The sensor controller 112 may be comprised in one of the sensors 114a-c or its functions may be distributed between a plurality of sensors 114. In one embodiment, the sensor controller 112 is seen as forming part of the behavioural analysis module 120.

Behavioural Analysis Module

The sensor controller 112 may be configured to communicate with the behavioural analysis module 120. The sensor controller 112 is configured to gather data from the at least one sensor 114a-c, or from the plurality of sensors 114a-c. The data is then processed in the system 100, using computer vision and/or machine learning techniques, in order to determine a behavioural information 122 of the customer 20. Computer vision and/or machine learning techniques will be described more in detail later on, but may for example relate techniques such as KNN, SVM, random forest, decision trees, neural networks, convolutional neural networks, linear regression and/or cascade classifier.

The behavioural analysis module 120 is preferably configured such that it is able to determine behavioural information for more than one customer 20 simultaneously.

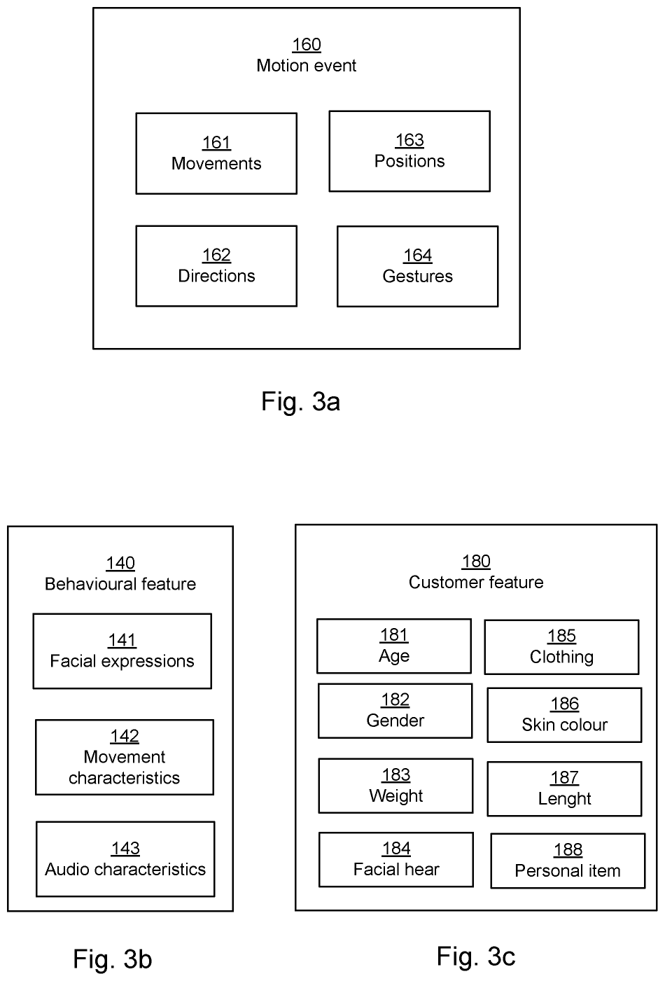

The sensor arrangement 110 is configured to collect sensor data, which together with computer vision and machine learning in the behavioural analysis module 120, is used to determine different aspects of a customer, such as his/her motion, facial expression, movement characteristics and/or other features of the customer. Some of these aspects are illustrated in FIGS. 3a-c, where the aspects are classified as three main groups; motion(s) event 160, behavioural feature(s) 140 and customer feature(s) 180.

The motion events 160 may be seen as comprising gesture events, a direction events, a body position events, and/or body movement events. The movements 161, positions 163, directions 162 and gestures 164 of the customer 20, may include and are not limited to head, face, arms, hands, fingers, eyes, torso, shoulders, neck, elbows, legs, knees, feet, hip wrist and/or nose.

A body movement event describes the movement of a customer 20 located in a specified area. The body movement event may be seen as approaching movement, leaving movement, stopped moving, turning body clockwise, leaning towards something, stretching, turning body counter clockwise and/or moving sideways.

A gesture event 164 can be seen as describing the gestures of a body inside a specified area. A gesture event may be seen as putting shopping basket grabbing shopping basket, grab item, grab item from surface, grab store bag, putting store bag, putting own bag, grab own bag, put gloves, grab from pocket, put in pocket and/or scan item.

A direction event can be seen as describing the direction of the head of a customer inside a specified area. A head direction event may be seen as nose pointing screen, nose pointing to a right wing area, nose pointing to a left wing area, nose pointing to a centre area, nose pointing to a bag section, nose pointing to a payment section, and/or nose pointing away from the system. The direction event can be determined in multiple ways, such as but not limited to nose direction, body direction and gaze direction.

In FIG. 3a, an exemplary embodiment of different motion events 160 are illustrated. Here the different motion events 160 are classified as movements 161 of the customer 20, the direction 162 which the customer 20 is facing, the position 163 of the customer 20 in the store or around a machine to which the system is applied, and/or the gestures 164 of the customer 20. Although not shown, the motion events 160 may further be seen as comprising the timing of the different motion events 160 associated with the customer 20.

In FIG. 3b, an exemplary embodiment of different behavioural feature(s) 140 are illustrated. Here the different behavioural features 140 are classified as facial expressions 141, movement characteristics 142 and audio characteristics 143.

The facial expressions 141 can also be seen as a mood event or emotions, and may comprise information relating to if the customer 20 is to be seen as being positive, happy, negative, angry, confused, stressed and/or calm.

The movement characteristics 142 may be seen as how the customer acts, such as if he/she is fast, is slow, is clumsy and/or to have jerky movements.

The audio characteristics 143 may be seen as audio sequences that the customer 20 produces. This may be talking, asking questions, screaming, mumbling, singing, being loud in general or being silent.

For this at least one audio sensor, for example a microphone or a microphone array, is preferably present in the sensor arrangement 110. A microphone array allows the system to detect the direction of the sound.

Another behavioural feature may be seen as an approximation of the heart rate of the customer 20. This can be estimated by analysing facial coloration of the customer 20. Tracking the heartrate will provide a metric of the state of the customer 20 as aggravation and frustration might increase the heartrate.

In FIG. 3c, an exemplary embodiment of different customer feature(s) 180 are illustrated. The customer feature 180 is mainly related to the visual appearance of the customer 20. In the embodiment of FIG. 3c, the different customer features 180 are classified as age 181, gender 182, weight 183, facial hair 184, clothing 185, skin colour 186, length 187 of the customer 20 and/or any presence of a personal item 188. It should be noted that the customer features 180 preferably are approximate values/states. For example, one customer feature 180 of the age 181 of the customer 20 may be directed at determining if the customer 20 is a child, adult or an elderly person. An approximation of age may also be performed using information relating to length 187, as a long person has a higher likelihood of being an adult than a child.

The customer feature 180 of facial hair 184 may comprise information relating to one or more of: presence of hair on the head, and if so, the length of hair and/or the colour of the hair, presence of a moustache, and if so, the length/colour of the moustache, and/or the presence of a beard, and if so, the length/colour of the beard.

The customer feature 180 of clothing 185 may for example comprise information relating to colour of clothing of the customer 20 as well as type of clothing of the customer 20, such as if it is covering his/her head and/or face, covering the arms, covering the hands, etc. Hence, the customer feature 180 may for example relate to detecting if the customer is wearing a trench coat or other bulky clothing. Moreover, the customer feature 180 may relate to the presence of accessories such as a scarf, a hat and/or sunglasses.

The customer feature 180 of personal item 188 may for example comprise information of the presence of a carry item, or personal item, that is easily removable from the body of the customer 20, or an external device. A personal item can for example be seen as having a mobile phone, a pair of gloves, a hat, an own bag, a store bag, a shopping trolley.

FIG. 4 shows that the sensor data 116 from the sensor arrangement 110 is transmitted to the behavioural analysis module 120 where the sensor data 116 is used to determine at least one motion event 160 of a customer 20 and at least one customer feature 180 of the customer 20. The behavioural analysis module 120 is then configured to determine behavioural information 122 of said customer 20 based on the at least one customer feature 180 and at least one motion event 160.

The at least one motion event 160 and the at least one customer feature 180 are determined using the sensor data 116 and one or more sensor processing techniques, such as computer vision and machine learning, video processing techniques, or other post-processing techniques that can be applied to sensor data. The sensor processing techniques that is applied to the sensor data 116 may be one or more of: machine learning, deep learning, convolutional neural networks, image processing, computer vision, human pose estimation, object detection, image classification, action classification and/or optical flow. The sensor data can also be processed using a color texture sensor and/or a color histogram sensor.

For example, detecting motion events 160 may be performed by implemented by e.g. having one or more sensor(s) 114a-c in the form of a camera that is directed at the customer 20, and using motion detection algorithms to detect and process the motion events 160 of the customer 20.

Another example of implementation will now be presented, where the aim is to detect the direction 162 of the customer 20. In this example, at least one sensor 114a-c is configured to detect the direction 162 that the customer 20 is facing by e.g. implementing one sensor 114a-c as a still or video camera capturing still images or video of the customer 20. Using machine learning techniques with pattern recognition, the face of a customer 20 may be identified and the position and the direction the customer 20 is facing may be determined. The face, or parts of the face, of the customer 20 may be tracked to determine if e.g. the customer 20 is moving his head and/or changing his focus of attention. Based on the location of the camera, it may be determined where, and also towards what, the customer 20 is facing, e.g. a packing area of the checkout system 40, a monitor/display or a cold/drinks section of the article containing areas A-I.

Detecting the position 163 of the customer 20 may be performed by detecting where the customer 20 is located in the store. If the system 100 is implemented in a checkout area, the position may be detected relative to the checkout system 40 so as to determine if the customer 20 is close to the packing area, the picking area or the scan area. The system may further comprise detecting if the customer is bending over, stretching to reach something, leaning or taking any other position 163. The detection of position 163 may for example be realized by having one sensor 114a-c embodied as a pressure sensor arranged on the floor and detect when the customer 20 puts weight on the sensor 114a-c by standing on it. Alternatively or additionally, one sensor 114a-c may be realized by a camera whose output is subjected to image analysis in order to detect the position 163 of the customer.

The position 163, or location, of the customer 20 may additionally or alternatively be detected by determining the distance from the sensor 114a-c to the customer 20 or by using more than one sensor 114a-c to triangulate the location of the customer.

The position 163, or location, of the customer 20 may additionally or alternatively be detected by a signature associated with his mobile phone or car key and which can be characterized by a particular radio frequency footprint. In some embodiments the footprint may be the MAC-address of the WIFI chip in the mobile phone of user, which may be provided to the sensor controller 112 by e.g. a WIFI sensor. The WIFI sensor may be configured to sense the MAC-address of users connected to a WIFI network of the store 10. The WIFI sensor may, additionally or alternatively be configured to provide a signal strength indicator to the sensor controller 112 describing the signal strength of the mobile phone associated with the customer 20. More than one of such sensors may be used in order to more accurately triangulate the position of the customer. Note that the MAC-address given as example above is but one example of data than may be used to identify the mobile phone of a customer 20 and use that mobile phone to track the customer. A Bluetooth signature, IP-address or cellular signature may be used in addition to, or as an alternative to, the example above.

The position 163 of the customer may additionally be performed using sensors in the form of cameras, that using image processing techniques, or computer vision and machine learning, is able to determine the position of the customer 20.

Detecting the timing of the motion events 160 customer 20 may be performed by associating some or all data points collected by the sensors with a time stamp. By tracking the time between events or changes detected by the sensors 114a-c, the system 100 can e.g. determine how long it takes for the customer 20 to scan one item and placing it in a packing area. It is also possible to track the time it takes between scanning of different items and the time from the arrival of the customer 20 to the first interaction with the checkout system 40. The timing may also be used to detect the time it takes for a customer 20 to e.g. pick up an article, scan it and place it in the packing area, the speed of such actions may be used by the behavioural analysis module 120 to determine behavioural information of the customer 20. For example, a customer 20 moving fast may be indicative of a more experienced customer 20.

Detecting the behavioural feature 140 of the customer 20 may for example be performed by tracking the face of a customer 20. This will enable the determining of the mood of the customer 20 by identifying changes in mood related characteristics of the customer 20 such as smile being brought on, pursing of lips, frowning and so on. The system 100 may be arranged to detect an initial characteristics of the customer 20 and track changes in the characteristics of the customer 20 to determine if his mood is changing throughout the shopping and/or checkout process.

Detecting the customer feature 180 of the customer 20 may for example be performed by having at least one sensor 114a-c realized as a camera, and using computer vision and/or machine learning and/or image processing and/or video analysis, to determine the customer feature 180 of the customer 20.

Behavioural Information

As shown in FIG. 4, the processed sensor data in the form of behavioural features 140, motion events 160 and optionally customer features 180 are used to determine behavioural information 122 of the customer 20. The determined behavioural information 122 of the customer 20 may be used for different purposes. For example, the determined behavioural information 122 may be used to determine statistical data 174, a guidance event for the customer 20 and/or a guidance event for store personnel in the store.

The behavioural information 122 may comprise a probability of a customer steeling, i.e. if the customer is to be regarded as “honest” or not (i.e. if there is a high probability that the customer does not steal). The probability of the customer 20 having paid for all his goods can be used for selecting customers for manual scanning where a manual inspection of the goods is compared to a list of goods provided by the self-checkout.

As previously stated, the behavioural information 122 may be used to determine and output statistical data 174. The statistical data may relate to statistics of the system 100. If for example the system 100 is arranged in a checkout area, the statistical data generated will relate to how customers 20 behave in a checkout area. Such information may be beneficial for the store owner and/or store personnel working in the store. The statistical data may be divided into different behavioural features, and may provide general information of the customers 20 in the system are happy, sad, irritated and so on. The statistical data may further comprise aspects of time, such as how long the different sections in the checkout area take on average. The statistical data may further comprise information relating to possible difference in the behaviour between young and adult customers 20.

The statistical information may be outputted as a report to an external device (such as a mobile phone, processing device, or the like), for example belonging to the store owner. The statistical data may also be used to learn and update the system 100, by using the statistical data as an input when determining future behavioural information 122 of a customer 20. Hence, the statistical data can be used for e.g. improving the system 100 through machine learning.

The statistical data may be stored in any suitable storage means, e.g. a cloud storage, data base or any other persistent storage means. The statistical data may be associated with a customer 20, a special part of the store, such as the checkout system 40 and/or the whole store 10. The behavioural analysis module 120 may use the statistical data in order to determine the accuracy of a determined behavioural information and/or as a self-evaluation means.

One example of how statistical data may be used, in a checkout system, will now briefly be described. If, for instance, a majority of the customers 20 are having trouble correctly placing the carrying arrangement 30 at a checkout system 20 on their first try, this can be compared to the number of customers 20 having trouble correctly placing the carrying arrangement 30 after receiving additional guidance. It may be that the initial guiding events are insufficient or unclear and should be changed in one way or another. Also, the statistical data may yield that virtually no customers have problems finding the in store shopping bags. In such cases guidance events related to the shopping bags may be removed and any output means 150 associated with this may be reduced or removed from the checkout system 40. The statistical data will enable the store 10 to save money by removing unused features and will produce a more efficient checkout process.

As seen in FIG. 4, the behavioural information may additionally or alternatively be used to provide guidance events. The guidance events may be guidance events for the customer 20, for store personnel or for both the customer 20 and the store personnel.

In one embodiment, the system 100 comprises one or more output means 150, arranged to provide guidance events based on the determined behavioural information 122 of the customer 20. The guidance events may for example be adjustment of light (on/off), adjustment of light intensity (lowering or increasing the intensity), adjustment of a sound level, displaying guidance instructions on a display, displaying a video clip on a display, displaying statistical information, transmitting a communication signal to the store personnel, transmitting a communication signal to a store owner, transmitting a communication signal to an external device of the customer 20, transmitting a signal to the gates of the store to open/close the gate, alert the store personnel, transmit a signal to the POS-system of the store 10 that the customer is not allowed to complete the payment session, and so on.

The guidance event for the customer 20 may for example be realized by a plurality of lighting device, such as LED-lamps. The lamps may be configured to perform different guiding events such as for example: flash left wing of an area, flash right wing of an area, flash the center of an area, flash a scanner device (such as a barcode reader), flash a payment device, directional light from left to center, directional light from right to center, directional light from center to left, directional light from center to right, pulsation of an left area, pulsation of a right area, pulsation of a center area and/or pulsation of all areas in the system.

The aim of the guidance event is either to help and guide the customer 20 towards finishing the process (such as a checkout process or a process of making a hot beverage) in a manner that is suitable for the specific customer 20, to alert/guide the store personnel that a customer needs manual help from the store personnel and/or that a part of the system needs maintenance or in other way needs attention.

The system 100 will further detect, using the behavioral information, if a customer 20 is using the checkout counter (or other area of the store where the system 100 is placed) in the “right way”. If this is the case, the system 100 may not prompt or guide the customer 20 further. In other words, if it is determined, based on the behavioral information 122, that the customer 20 is acting as intended the guidance event will not be altered from the original guidance event.

Moreover, the system 100 will further detect, using the behavioural information 122, if a customer 20 is acting in a deviant way. This may indicate that the customer is either intending to steal an article, or that the customer 20 is in need of more guidance in order to complete the process.

If the behavioural information 122 indicates that the customer 20 has bad intentions, the at least one output means 150 may informing the customer, instruct the customer, notify store personnel, transmitting a signal to the checkout system in the store, block payment for the customer and/or transmitting a stop signal to an exit gate of the store to block the opening of the exit gate, and so on. If the system 100 has determined that a customer 20 has a deviant behaviour, the system 100 may transmit instructions to execute an anti-theft operation. The anti-theft operation may comprise one or more of the following: informing the customer, instruct the customer, alerting store personnel, transmitting a block signal to the checkout system in the store, block payment for the customer and/or transmitting a stop signal to an exit gate of the store to block the opening of the exit gate.

The behavioural information 122 may further be used to determine a guidance level of the customer 20. The guidance level may be any type of metric that suitable to classify and/or categorize the customer's 20 estimated need of guidance. In one embodiment the guidance level is any number between 0 and 5 where 0 corresponds to no guidance and 5 corresponds the most guidance, with the intermittent number scaling between the two extremes. Similarly, in another embodiment, the guidance level is described in percentages between 0% and 100% where 0% corresponds to no guidance and 100% corresponds to the most guidance. The guidance level shall be seen as a relative metrics that will be used specifying if the guidance level should be increased, decreased or unchanged.

The behavioural analysis module 120 may be configured to instruct the output means 150 to provide guidance events to the customer 20. The guidance level associated with the customer 20 may be continuously updated by the behavioural analysis module 120. If it is determined that additional guidance events are needed, the guidance level of the customer 20 may be increased by the behavioural analysis module 120 as the output means 150 is instructed to provide the guidance event(s). The opposite is of course also possible, wherein the behavioural analysis module 120 determines that certain guidance event(s) need not be given and as that is communicated to the output means 150, the guidance level of the customer 20 may be decreased.

In some embodiments, the behavioural analysis module 120 may identify the customer 20 and determine the guidance level based on a historical guidance level associated with the customer 20. In some embodiments, the historical guidance level is retrieved from a database comprising customer information based on an identification of the customer 20. The identification of the customer may either be from the sensor arrangement 110, from facial recognition algorithms, from loyalty cards, credit cards, NFC on a mobile device of the customer 20 or the like. The behavioural analysis module 120 may update the historical guidance level associated with the customer 20 if the guidance level is changed during the current transaction.

The behavioural information 122 may further be used to determine a probability level of the customer 20. The probability level may relate to the likelihood that the customer 20 will steal from the store 10. Additionally, or alternatively, the probability 176 of the customer may comprise a probability that the customer 20 will fail to scan or more articles by e.g. mistake or negligence.

For instance, if the customer has identification obscuring means, such as for example sunglasses or a hat, the number of articles in the carrying arrangement are few and the behavioural features 140 indicates that he/she is nervous, the probability of the customer 20 stealing may be increased. In such events, the customer behavioural system 100 may indicate to store personnel or security that the customer 20 is eligible for manual scanning of articles. Similarly, a customer associated with a low guidance level acting confident and not being distracted during the checkout process may be associated with a low probability of both stealing and making mistakes. Consequently, the probability will enable the reduction of shop lifting and abuse of the checkout system 40 at the same time as store personnel and/or security will be more efficiently utilized in manual scanning of customers 20.

In the following the customer behavioural system 100 will be arranged in a checkout area of a store 10. However, it should be understood that the system 100 could be applied in other parts of a store 10 where behavioural information might be useful.

One such area in a store is a drink machine area where the customer 20 can buy a hot drink, such as coffee or tea. The drink machine is preferably used by the customer 20 itself, and there might thus be benefits of being able to gain statistical data and/or to provide guidance events. The guidance event to the customer 20 may be to indicate, for example by lights, sound or images/text on a display how to correctly buy a hot drink. The guidance events to the store personnel may for example relate to performing service events on the machine, and/or to alert that a customer 20 is misusing the machine.

Another area in a store where the behavioural system 100 can be useful is in the entrance area of the store 10, where the customer 20 picks article carrying device(s), and/or possibly borrowing a portable scanner for self-checkout.

Moreover, depending on where the customer behavioural system 100 is placed in the store, the system 100 may further use sensor data, and computer vision and machine learning analysis, that originates from a different area of the store. For example, if the customer behavioural system 100 is arranged in a checkout system 40, data may be used from other sub-systems in the store such as an entrance system or movement tracking system that tracks the customer during its shopping session.

Customer behavioural system arranged in a checkout system

In one embodiment, the customer behaviour system 100 is arranged in a checkout system 40, as is shown in FIG. 5. In this embodiment, the checkout system 40 comprises a first area 41, a second area 42 and a third area 43. The first area 41 may be seen as an unpacking area 41 where the customer 20 places his articles that are to be purchased, for example by putting an article carrying device 30 containing the articles, on the unpacking area 41.

The second area 42 may be seen as a scanning area 42, being arranged with an identification means 45 that is configured to identify the articles. The identification means 45 may be a scanning means, for example in the form of a barcode reader. The second area 42 may further be arranged with a display 46, arranged to display information relating to identified article, such as the name of the article, price, etc. The display may be in a form of a non-touch display or a touch-display. The second area 42 may additionally be arranged with customer identification means 47. The customer identification means 47 may be configured to identify the customer 20, for example by the customer scanning an identification card on the identification means. The second area 42 may additionally be arranged with payment means 48. The payment means 48 may for example be a card reader, a connection point to a mobile payment and/or a cash payment system. It should be understood that the checkout system 40 may comprise all of these features, none of this features, one or a combination of a few. The features could be arranged in the second area 42, as exemplified above, and/or in the first and/or third area.

The third area 43 may be seen as a packing area 43, arranged to be an area where the customer 20 is placing its identified articles. The customer 20 may place the articles directly on the third area 43, or in a bag or similar receptacle being placed thereon. The third area 43 may comprise a scale 44 arranged to weigh the articles being placed thereon.

The checkout system 40 may further be arranged with output means 150. In this embodiment, the output means 150 is configured to provide guidance events to the customer 20 and/or to store personnel. However, as previously mentioned the output means 150 may additionally or alternatively be arranged as a communication unit to provide statistical information to the store 10, to other systems arranged in the store 10 and/or to store personnel.

In this embodiment the output means 150 is illustrated by the dotted line in FIG. 5. The checkout system 40 of FIG. 5 may have an output means 150 comprising at least one light source. In a preferred embodiment, the output means 150 has at least one light source in each of the areas 41, 42, 43. The light sources may be any suitable light source, e.g. LED light sources. The light source may be configured to have different color and/or intensity depending on the guidance level associated with the customer 20. Moreover, the light sources may be activated in different modes, for example in a dimmed mode, a flashing mode, a “pointing” mode, and a “flowing” mode. The light sources may provide shorter non-continuous indications, directional light and/or continuous slow changes of the intensification of the light.

Additionally or alternatively, the output means 150 is realized as a display 46. In this embodiment, the display 46 is arranged in the checkout system 40. The display 46 is arranged to provide guidance to the customer 20 and/to store personnel regarding the checkout process of the checkout system 40. The output means 150 will provide guidance based on the behavioural information 122 provided by the behavioural analysis module 120. The output means 150 may be arranged to show video clips or animations of how to e.g. scan or weigh an article, how to place a store bag in the packing area 43, where to place a basket of articles in the picking area 41 etc.

Depending on the behavioural information 122 determined by the behavioural analysis module 120, different content may be displayed on the display. In one embodiment, the output means 150 comprises both a plurality of light sources as well as at least one display 46. Although not illustrated in FIG. 5, it should be understood that the output means 150 may be extended to include other areas of the checkout system 40 and/or other parts of the store 10.

The conceptual idea of the customer behavioural system 100 is to analyse the behaviour of the customer, by determining behavioural information, in order to provide an output. The output may be a guidance event of the customer 20. In order to exemplify this, the following paragraphs describes how the behavioural system 100 is used to determine the behavioural information, and to provide the correct output to the customer based on its behavioural information. A very skilled customer 20 will have behavioural information that indicates that he/she is in need of little or no guidance events whilst an inexperienced customer 20 will have behavioural information that indicates that he/she will require a high level of guidance events. The behavioural information is determined by the behavioural analysis module 120 at least based on data from the sensor arrangement 110. The output is provided to the customer, store personnel or to the system by the one or more output means 150.

If the customer 20 starts scanning items without having received guidance events indicating her/him to do so, the behavioural information associated with the customer 20 may be adjusted, in this example the behavioural information will comprise information that the guidance events are sufficient and/or needs to be lowered. If the customer 20 seems hesitant (for example in that his gaze, posture or heartrate indicate that he is confused or stressed), the behavioural information associated with the customer may be adjusted, in this case the behavioural information will comprise information that the guidance events are insufficient and needs to be increased. Confusion may be characterized by e.g. the customer 20 scratching his head, frowning or looking around as if looking for assistance.

As previously been described, the behavioural system 100 may detect different events based on motion events 160 of the customer, behavioural features 140 of the customer and customer features 180. The system 100 may thus detect many different events in a checkout system. The following detections should only be seen as an non-extensive list of detection events. The system may detect when an article is picked up from the picking area or carrying arrangement 30 by the customer, determine when an item is being scanned, determine when an item is placed in the packing area, detect when the customer 20 removes one or more items from the pickup area, identify what type of article the customer 20 removed from the picking area, detect if an item is placed on a scale, detect when an item is given to another person at the checkout system 40, detect if an item is placed in e.g. a pocket of the customer 20, detect movement of a personal item of the customer, detect payment, detect when the customer 20 is done with checking out articles, and detect when the customer 20 leaves the checkout system 40. Based on the different events, different guidance events may be provided by the system 100.

Some specific examples will now be presented. If the system 100 determines that a person has put an item into his jacket, the following sequence may be performed. The system 100 will determine if the item was correctly scanned prior to it being placed on the person of the customer 20. If this was the case, the system 100 may provide an output in the form of a guidance event, either to the customer and/or to the store personnel, indicating that the action was allowed. If the item was not correctly scanned, the system may provide a guidance event to the customer that indicates that the customer needs to scan the item. Additionally or alternatively, a guidance event to the store personnel is provided indicating that an unallowable event has occurred. The behavioural analysis 120 module may further be configured to determine if the customer 20 is likely to steal goods, based on the determined behavioural information. This information may then be provided as a guidance event to the store personnel, wither through the output means and/or a store surveillance system. This output may indicate the store personnel that a manual check of the items purchased by the customer should be performed. The likelihood of the customer 20 being likely to steal, by mistake place un-scanned goods in the packing area or forgetting to scan items may be determined based on the determined behavioural information of the customer. A customer 20 determined to have behavioural information that indicates a high guidance level may be more prone to make mistakes and can be more likely to be selected for manual inspection of correctness of transaction. Similarly, a customer 20 determined to have a behavioural information indicating a low guidance level may be chosen for manual inspection if his gaze is shifting and he is acting nervous but the efficiency of the checkout is still high.

Another example is provided relating to the payment process. When the customer 20 is done with checking out articles, the behavioural analysis module 120 may provide guidance events to the customer relating to the payment. If the behavioural analysis module 120 detects abnormalities, e.g. un-scanned items left in the picking area during the payment process, the behavioural analysis module 120 may provide a guidance event relating to inform the customer 20 and/or the store personnel of these abnormalities. If the customer 20 leaves the checkout system 40 without having completed the transaction, the behavioural analysis module 120 may provide a guidance event that to pauses the guidance events and/or the checkout process for a period of time allowing the customer 20 time to return and finalize the checkout. It may be that the customer is heading to pick up forgotten items in the store 10 or urgently needs run after his/her children, the behavioural analysis module 120 may be configured to detect such events to adjust the duration of the pause accordingly.

One example relating to the specific feature that the customer is determined to be distracted, i.e. the behavioural information comprises information that indicates that the customer is distracted. If the behavioural analysis module 120 determines that the customer is distracted, the output generated may be to instruct the output means 150 to pause or decrease the guidance events. The customer 20 may be determined to be distracted if the customer is e.g. facing away from the checkout system 40, talking on the phone, talking to a friend etc. When the customer is distracted the decreased guidance will reduce the risk of stressing the customer 20 allowing him time to handle the distraction without being stressed by prompts and alerts from the output means 150. Once the customer 20 is determined not to be distracted, the output means 150 may be instructed to continue the guiding events.

The behavioural analysis module 120 is, in one embodiment, continuously receiving data from the sensor arrangement 110 and determining if the guidance level of the customer 20 should be increased, decreased or left unchanged. If a skilled customer 20 suddenly gets lost and acts confused, the behavioural analysis module 120 will detect this and increase the guidance level associated with the customer. If a customer 20 starts performing his tasks at an increased speed or if he shows signs of irritation when the output means 150 is providing guidance, the guidance level may be decreased.

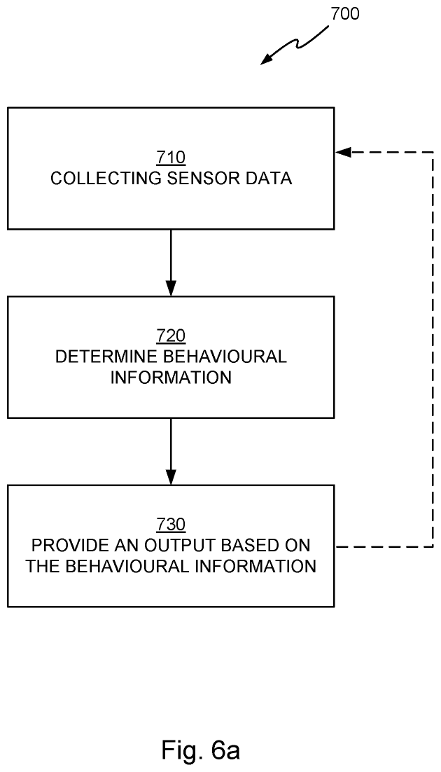

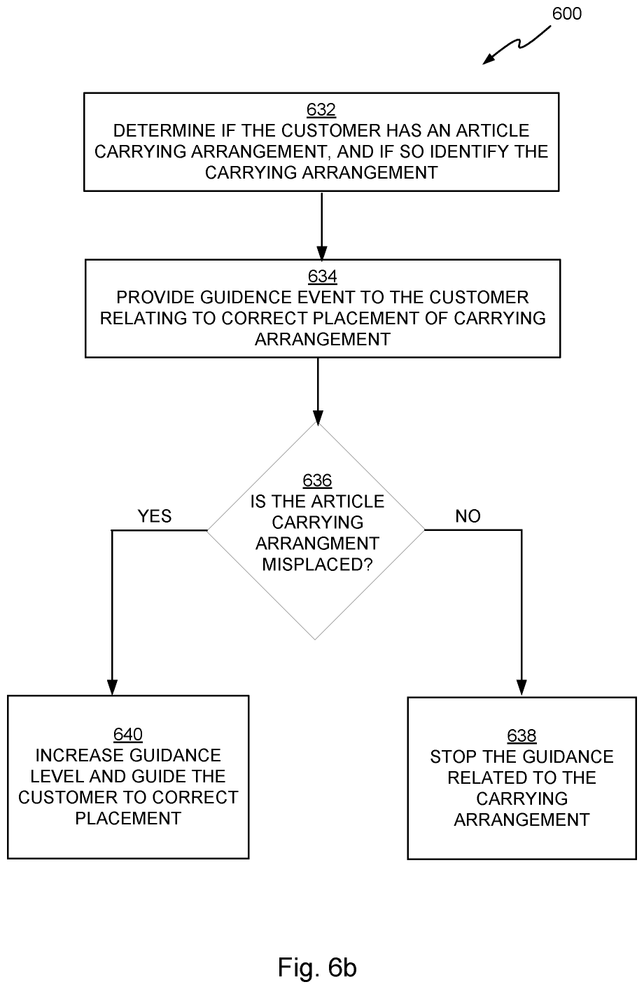

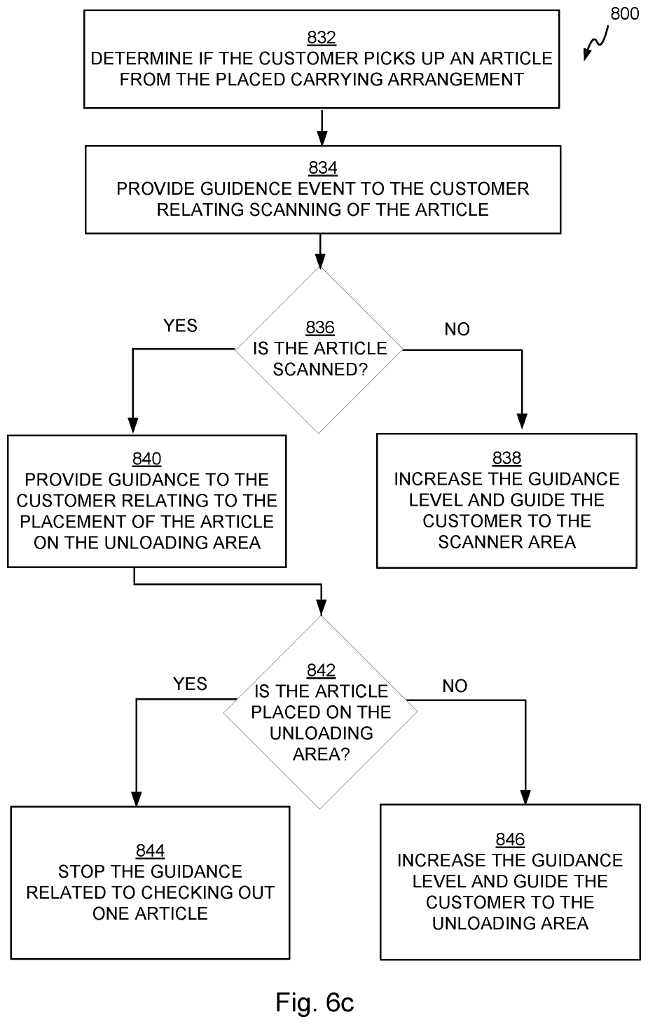

With reference to FIG. 6a, method 700 of determining behavioural information to a customer is illustrated. The method of providing behavioural information 700 is suitable to be used in a store 10 and may be performed by the customer behavioural system 100 as previously presented. The customer behavioural method 700 comprises the steps of collecting 710 sensor data regarding a customer 20, determining 720 a behavioural information associated with the customer 20 and providing 730 an output based on the behavioural information. In the following, the method will be used in a checkout area 40 of a store.

The method may be run continuously as indicated by the dashed feedback line in FIG. 6a from the step of providing 730 an output to the step of collecting 710 sensor data. Hence, the behavioural information of the customer 20 may be updated continuously during the use of the checkout system 40.

The step of collecting sensor data 710 may comprise the step of detecting that a customer 20 is approaching the checkout system 40. The detection of a customer 20 may initiate one or more sensors of the sensor arrangement 110, these sensors may then be used to determine the guidance level.

During a checkout process, the system 100 may perform a plurality of different sequence, for example relating to placement of the article carrying arrangement, scanning of an article, placement of scanned articles and relating to the payment. In one embodiment, the behavioural information is updated after each completed sequence. Additionally or alternatively, the behavioural information is updated continuously at a predetermined time interval.

In the following examples, the method will be used in a checkout area 40 of a store, and the output is related to providing a guidance event to the customer.

FIG. 6b is a flowchart illustrating one, of many, possible sequence performed by the system 100 during checkout of a customer 20. The sequence in FIG. 6b is related to providing guidance events to the customer 20 regarding the placement of the article carrying arrangement. The system 100 is configured to determine if the customer 20 is having any type of article carrying arrangement 30. If it is determined that the customer 20 has an article carrying arrangement 30, the system 100 may further be configured to identify the type of the carrying article arrangement 30 the user is having, for example if it is a personal bag or backpack or if it is a shopping cart. It should be noted that the step of identifying the type of the article carrying arrangement 30 is optional.

Based on the determined 632 carrying arrangement 30, the behavioural analysis module 120 may provide 634 guidance events to the customer the customer 20 to a correct placement of the carrying arrangement 30. If the customer 20 approaches with a shopping cart, the behavioural guidance system 100 may provide instructions to the output means 150 to instruct the customer 20 where to park or place the shopping cart. If the customer arrived with a shopping basket, the customer behavioural system 100 may provide guidance events relating to where to place the basket.

The customer behavioural system 100 may be configured to determine 636 if the customer 20 misplaces the carrying arrangement 30 and instruct the output means 150 to provide a guidance event 640 the customer 20 if the placement was incorrect.

If the customer 20 is identified as having goods in his hands or under his arms, the customer behavioural system 100 may provide guidance events, using the output means 150, to e.g. instruct the customer 20 to immediately scan the goods and/or place the goods in the first area 41. As before, the speed and/or decisiveness of the customer 20 may be used to determine the behavioural information of the customer 20. A decisive customer 20 may be identified by e.g. a constant movement without hesitation such as a shifting gaze.

The customer behavioural system 100 may further be configured to determine 636 that the carrying arrangement 30 is correctly placed, and thus stop 638 the guidance events related to the placement of the carrying arrangement 30.

A similar sequence, not shown in FIG. 6b, may be performed to guide the customer 20 to correctly place an article carrying arrangement in the packing area 43. The behavioural analysis module 120 may be configured to identify if the customer 20 is placing his own bag in the packing area 43, if he is placing a store bag in the packing area 43 or if he does not place any bag at all in the packing area. If no bag is being placed in the packing area 43, the behavioural analysis module 120 may provide guidance event, using the output means 150, to help the customer 20 to the location of the store bags. If the behavioural analysis module 120 has determined that the customer 20 has a behavioural information that is associated with a high guidance level (i.e. needs a lot of guidance events), the behavioural analysis module 120 may instruct the output means 150 to provide guidance events to the customer 20 relating to how and/or where to place the bag. Further to this, behavioural analysis module 120 may be configured to determine when the bag is placed on bag holders of the checkout system 40 and/or if the bag is correctly placed on the bag holders. If the bag is determined to be incorrectly placed, the behavioural analysis module 120 may instruct the output means 150 to provide guidance to the customer 20 relating to the placement of the bag. Any action taken, or not taken by the customer 20, may cause the behavioural analysis module 120 to adjust the determined behavioural information of the customer, and thus adjust the provided guidance events.

FIG. 6c is a flowchart illustrating one, of many, possible sequence performed by the system 100 during checkout of a customer 20. The sequence in FIG. 6c is related to providing guidance events to the customer 20 regarding scanning articles. The system 100 is configured to determine 832 if the customer picks up an article from its carrying arrangement. If it is determined that the customer 20 has picked up an article, the system 100 may further be configured to provide 834 guidance event(s) to the customer regarding how/where to scan the article. The system then determines 836 if the article has been scanned or not. If it is determined that the article has not been scanned, the system is configured to increase the guidance level, or increase the guidance event, and guide the customer to the scanner. If it is determined that the article has been scanned, the system is configured to provide guidance for the customer to place the scanned article on an unloading area.

When it is determined that the article has been scanned, the system determines 842 if the article is placed on the unloading area. If it is determined that the article is not placed on the unloading area, the system increases 846 the guidance level, or increases the guidance event, in order to guide the customer to the unloading area. If it is determined that the article is placed on the unloading area, the guidance event relating to checking out that article is stopped 844. This system may be loped for all articles that are arranged in the carrying arrangement 30 of the customer 20.

### FIRST EXAMPLE

In one example, a customer 20 approaches the checkout system carrying a shopping basket and it as the same time wearing a backpack. The system 100 detects that the customer 20 is approaching the checkout system 40. The customer 20 arrives at the checkout system 40, stops and hesitates. As the customer arrives, the sensor arrangement 110 detects the presence of the customer 20 and starts detecting data relevant for the behavioural analysis module 120 to detect behavioural features 140 of the customer 20 as well as motion event 160 of the customer. Optionally, the behavioural analysis module 120 further detects customer features 180. As the customer stops and hesitates, the behavioural analysis module 120 determines behavioural information of the customer 10, and possibly identifies the article carrying arrangement 30 as a shopping basket. The behavioural analysis module 120 instructs the output means 150 to provide a guidance event that indicates the picking area 41, for example with a flashing green light.

The customer 20 places the shopping basket in the packing area 43. As the customer 20 places the shopping basket in the packing area 43, this incorrect placement is identified by the system 100. This information is used to update the behavioural information of the customer 20. The behavioural analysis module 120 instructs the output means 150 to provide a guidance event indicating the picking area 41. This may for example be performed by a flashing a green light in the picking area 41 and a flashing red light in the packing area.

The customer 20 moves the shopping basket form the packing area 43 to the picking area 41. The placement of the shopping basket is detected by the system 100 and the output means 150 is instructed, by the behavioural analysis module 120, to provide a guidance event that stops or lowers the light indications. The system 100 collects data regarding the weight of the shopping basket, by means of a weight sensor comprised in the picking area 41, and provides the behavioural analysis module 120 with a picture of the content of the shopping basket. The behavioural analysis module 120 analyses the picture of the shopping basket and estimates that there are four items in the shopping basket.

The customer 20 removes his backpack and looks hesitantly at the checkout system 40. The system 100 detects the change in the customer 20 and the behavioural analysis module 120 determines that the customer 20 is holding a personal bag, and instructs the output means to provide a guidance event indicate the packing area 43, for example with a green flashing light. The system 100 may in some embodiments visually estimates the weight of the personal bag.

The customer 20 acknowledges the green flashing light of the packing area 43 by placing his backpack in the packing area 43. The system 100 detects the personal bag in the packing area and provides this information together with the weight of the backpack, as input to the behavioural analysis module 120. The behavioural analysis module 120 adjust the behavioural information of the customer, for example by decreasing the guidance level associated with the customer and estimates the risk of shoplifted items in the personal bag. This may for example be based on the difference between the visually estimated weight and the weight reported by the weight sensor of the packing area 43. The behavioural analysis module 120 instruct the output means 150 to provide a guidance event indicating scanning of articles with a friendly rolling green light at the picking area 41.

The customer picks up a packet of butter from the shopping basket. System 100 notes the change in weight at the picking area and the system 100 instructs the output means 150 to provide a guidance event that moves the indications from the picking area 41 to the scanning area 42.

The customer holds the packet of butter at the scan area 42. The system 100 determines that the article has been scanned by means of a bar code scanner comprised in the scan area 42. Once this is detected, the behavioural analysis module 120 may instruct the output means 150 to provide a guidance event that moves the indications from the scan area 42 to the packing area 43.

The customer places the packet of butter in his backpack on the packing area 43. The system 100 notices the change in weight on the packing area 43 and the system 100 determines that the increase in weigh on the packing area 43 is essentially the same as the decrease in weight on the picking area 41 when the packet of butter was removed from the shopping basket. The system 100 further notes that there are three items left in the shopping basket and instructs the output means 150 to provide a guidance event that moves indications from the packing area 43 to the picking area 41.

The customer 20 picks the next item in the basket and the process is repeated until the second last article is picked, at which point the customer 20 receives a phone call and answers his cell phone. The system 100 senses the removal of one item from the picking area 41, detects the motions of the customer 20 while at the same time not detecting any activity in the scan area 42 or the packing area 43. The system 100 thus determines that the customer 20 is distracted and pauses the guidance events provided by the output means 150.

The customer 20 places the item in the scan area 42. The system 100 determines that the item has been scanned, however the system 100 determines that the behavioural information still indicates that the customer is distracted, and outputs no further guidance events.

The customer ends his call and looks confusedly at the checkout system 40. The system 100 detects the ending of the call and determines, based on the updated behavioural information, that the customer 20 is no longer distracted. The behavioural analysis module 120 instructs the output means 150 to provide guidance events to the customer indicating that he/she should remove the item from the scan area 42 and place it in the packing area.

The customer 20 follows the instruction and picks the last item from the shopping basket, a bunch of bananas sold by weight, at which point the customer 20 hesitates once more. The system 100 detects that the last item of the shopping basket is removed and the system 100 determines that the weight of the shopping basket is the only weight remaining on the picking area 41. The system 100 detects confusion of the customer 20, and updates the behavioural information accordingly so as to comprise information that the customer is confused and needs more guidance events. The behavioural analysis module 120 instructs the output means 150 to provide guidance events that moves the indications from the picking area 41 to the scan area 42. The system 100 determines that it is likely that the item held by the customer 20 is an article sold by weight and instructs the output means 150 to provide a guidance event that indicates, for example on a display means in the vicinity of the scan area 42, that the scan area 42 has weighing capabilities.

The customer 20 looks relieved at the increased guidance and places the bunch of bananas on the scan area 42. The system 100 receives information of the weight of the bananas and records a picture of the scan area 42. The behavioural analysis module 120 analyses the picture and determines that the article in the scan area 42 is a bunch of bananas and instructs the output means 150 to prompt, on the display, the customer 20 to indicate if the bananas are organic or not.

The customer 20 presses an icon on the display indicating organic bananas. The system 100 instruct the output means 150 to provide a guidance event that moves indications from the scan area 42 to the packing area 43.

The customer 20 places the bunch of bananas in his backpack. The system 100 determines the change in weight and the behavioural analysis module 120 determines that essentially the same weigh change was recorded with regards to the bunch of bananas in both the picking area 41, the scan area 42 and the packing area 42. The behavioural analysis module 120 determines that all articles are correctly scanned and instructs the output means 150 to stop all current indications and prompt the customer to select payment a payment option on the display.

The customer 20 selects an RFID enabled payment option on the display. The behavioural analysis module 120 outputs a guidance event to the output means 150 to visually indicate the location of the payment means in the checkout system 40. The customer 20 pays for his purchase by following the visual indications, completes the transaction by taking his backpack from the packing area and leaving the checkout system 40.

Training

The customer behavioural system 100 may be subject to training, or learning, in order to improve the accuracy of the determination of the guidance level of the customer 20. For example, the sensor arrangement 110 may be activated during predetermined training sessions, in which the same or different store attendants uses the customer behavioural system 100 with a predefined usage pattern for training the system.

Initial training will be performed by the patent assignee or designated partners before delivery to the store 10. This is to ensure that the data is annotated and tagged correctly. The initial training sessions will be performed according to pre-defined flow schedules.

Additional training may be performed on site, in the store, in order to increase the performance of the system 100. In this case, the store attendant may e.g. start using a mobile phone during checkout, turn his back to relevant sensors 114a-c of the sensor arrangement 110 etc., all per the predefined pattern. This allows the behavioural analysis module 120 to update its decision criteria when determining if e.g. the checkout process should be paused due to the customer 20 talking on the phone, turning his back or being otherwise unfocused, since the store attendant(s) provides a key to the predefined usage pattern.

System learning may further be improved by using checkout counters, either manually operated, semi-automatic operated, or fully automatically operated.

The training, or learning, may also occur during normal operation of the store 10 and the checkout system 40, where the behaviour of a customer 20 may be associated with the latest action taken by the customer behavioural system 100. In one embodiment, this comprises tracking the behaviour of the customer 20 when the guidance events have been paused due to a determination of the behavioural analysis module that the customer 20 is distracted. If the customer is acting irritated, annoyed and for instance immediately manually resumes the checkout process, the determination of the customer 20 as distracted may be classified as faulty and the decision criteria for a distracted customer 20 may be updated accordingly.

Additionally or alternatively, the customer behavioural system 100 may be scheduled for calibration and/or training by e.g. a store attendant if more than a predetermined or configurable number of faulty decisions have been taken by the customer behavioural system 100. The embodiment above is given with a distracted customer 20, but it is understood that the same applies mutatis mundus in all determinations.

In one embodiment the sensor arrangement 110 may be activated during predetermined training sessions in order to learn the system to recognize different movements of a user's (customer or store attendant) hand/and or arm while being in or near to the picking area 41 and/or the article carrying device 30. The system 100 is preferably learned to differentiate between different movement directions, i.e. from/away from the article picking area 41 and/or the article carrying device 30. This is beneficial when determining if the article is fetching an article from the article picking area 41 and/or the article carrying device 30 and when determining if an article is removed from the article picking area 41 and/or the article carrying device 30.

In one embodiment, the customer behavioural system 100 is trained or learned using synthetic training data. The system is trained on a synthetically generated dataset with the intention of transfer learning data to real data. The use of synthetic data has several advantages, for example once the synthetic environment is ready it is fast and cheap to produce as much data as needed, and the synthetic environment can be modified to improve the model and training. Moreover, synthetic data can be used as a substitute for certain real data segments that contain, e.g., sensitive information.

In a preferred embodiment, the synthetic environment is a 3D-model of the store 10, the checkout system 40, the checkout area 60 and/or of the article carrying device 30. Hence, the training data may comprise of a synthetically generated 3D-model of at least a part of the store 10 and/or the customer 20 and/or the checkout area 60.

The synthetic environment is used to train the system to recognize customers 20 of different skin colors and skin variations. Additionally, the system 100 is trained to recognize customers 20 of different sizes, such as being of different height and weight.

The synthetic data may be enhanced by using Generative Adversarial Networks (GAN). GAN is able to adapt the synthetic data so that it increases it resemblance to the reality. GAN is a deep neural net architectures comprised of two nets, pitting one against the other. In GAN, a neural network generates new data instances, this neural network may be referred to as a generator. The generator takes in random numbers and then returns an image, this image is then feed into another neural network called the discriminator. The discriminator evaluates the data instances for authenticity, hence this neural network decides whether each instance of data it reviews belongs to the actual training dataset or not. The image received from the generator is transmitted to the discriminator together with a stream of images taken from the actual dataset. The discriminator is arranged to receive both real and fake images. Based on these images, it returns probabilities in the form of a number between zero and one. The number zero represents a fake image and with the number one represents a prediction of authenticity. In a next step, a double feedback loop is created. The discriminator is in a feedback loop with the ground truth of the images, while the generator is in a feedback loop with the discriminator. During the training phase, the generator will continuously improve and eventually be able to generate images that closely resembles real data.

In one embodiment, training data is automatically recorded once the system is in use. This data may later be used to re-train the system. This gives the system a more robust and reliable training. Once the training data is recorded, the recorded data may be analysed. The analysis may for example include determining confidence level of different “actions”, such as for example motion events 160 of the customer 20, behavioural features 140 of the customer 20 and/or customer features 180 of the customer 20. The confidence level for the different events/features may comprise information relating to if the event/features are correctly identified by the system or not. Event/features having a low confidence level may need further validation and possibly manual annotation. This information is then added to the training data. Event/features having a high confidence level may not need any further validation or re-annotation.

From the previous sections, describing the sensor arrangement 110, the behavioural analysis module 120, the output means 150, and the associated training and methods, it is evident that the number of combinations of embodiment of each of the modules 110, 120, 150 and the method 700 are numerous. All suitable combinations of these embodiments are possible and the skilled person will understand what constitutes a suitable combination. It should be noted that the customer behavioural system 100, its training and associated method as disclosed herein, may be implemented in numerous ways. Parts of the system 100, the methods or the training may be implemented using hardware components and other parts may be implemented using software that, when executed by an associated hardware component, performs the desired tasks.

As a general note, the customer behavioural system 100 has been illustrated as comprising three separate blocks or modules 110, 120, 150. This is for explanatory purposes and the skilled person will realize, after reading this disclosure, that some functions described in association with e.g. the behavioural analysis module 120 may be performed by the sensor arrangement 110 and vice versa. Consequently, the functions should not be considered as locked to a particular block or module 110, 120, 150.

1. A customer behavioural system in a store, the customer behavioural system comprising:
a sensor arrangement comprising one or more sensors, and
a behavioural analysis module configured to:
determine at least one behavioural feature of a customer based on sensor data from said one or more sensors, and/or determine at least one motion event of a customer based on sensor data from said one or more sensors, and
determine behavioural information (for said customer based at least on one determined behavioural feature and/or at least one determined motion event.

2. The customer behavioural system according to of claim 1, wherein the behavioural information is at least used to provide guidance events for a customer, provide guidance events for store personnel and/or to provide statistical information to the customer behavioural system.

3. The customer behavioural system according to of claim 1, wherein the behavioural information is at least used to control at least one output means.

4. The customer behavioural system according to claim 3, wherein the output means comprises at least one of: a light source, a sound emitter, a display and/or a communication unit.

5. The customer behavioural system according to claim 1, wherein the behavioural feature of a customer comprises information of facial expression of the customer, information of audio characteristics of the customer and/or information of movement characteristics of the customer.

6. The customer behavioural system according to claim 1, wherein the motion event comprises information of at least one of: movements of the customer, position of the customer, direction of the customer or gestures of the customer.

7. The customer behavioural system according to claim 6, wherein said movement, position and/or direction of said customer comprises a movement, position and/or a direction of said customer's head, face, arm(s), hand(s), torso, shoulder(s), neck, elbow(s), leg(s), knee(s), feet, fingers, hip(s), wrist , nose or a gaze direction of the customer.

8. The customer behavioural system according to claim 1, wherein determining at least one motion event of a customer at least comprises continuously tracking, by the sensor arrangement, the movement of the customer.

9. The customer behavioural system according to claim 1, wherein the step of detecting at least one motion event of a customer at least comprises detecting when an article, to be purchased by the customer, is moved.

10. The customer behavioural system according to 9, wherein the step of detecting at least one motion event of a customer at least comprises detecting the direction of movement of the article.

11. The customer behavioural system according claim 1, wherein the sensor arrangement further is configured to detect at least one customer feature of a customer based on data from said one or more sensors, and wherein the behavioural analysis module is further configured to determine behavioural information for said customer based at least on one behavioural feature of the customer, at least one motion event of the customer and at least one customer feature of a customer.

12. The customer behavioural system according to of claim 11, wherein the customer feature comprises estimated information of at least one of: age of the customer, gender of the customer, clothing of the customer, weight of the customer, facial hair of the customer, skin colour of the customer, the length of the customer, and/or a personal item of the customer.

13. The customer behavioural system according to claim 1, wherein the behavioural analysis module is further configured to use machine learning to determine behavioural information of the customer by associating sensor data with previous usage of the system.

14. The customer behavioural system according to claim 1, wherein the behavioural analysis module is further configured to use statistical analysis to determine behavioural information of the customer.

15. The customer behavioural system according to claim 1, wherein the behavioural analysis module is further configured to use the determined behavioural information to determine if the customer has a deviant behaviour.

16. The customer behavioural system according to of claim 15, wherein if it is determined that a customer has a deviant behaviour, the system will transmit instructions to execute an anti-theft operation.

17. The customer behavioural system according to of claim 16, wherein the anti-theft operation comprises any one of: instruct the customer, alerting store personnel, transmitting a block signal to checkout system of the store, block payment for the customer and/or transmitting a stop signal to an exit gate of the store to block the opening of the exit gate.

18. The customer behavioural system according to claim 1, wherein at least one of said one or more sensors is one of: a 2D-camera, 3D-camera, weight unit, radar unit, LIDAR-unit or microphone.

19. The customer behavioural system according to claim 1, wherein the customer behavioural system is arranged to be used in a checkout system, and wherein the checkout system comprises one or more identification means.

20. The customer behavioural system according to of claim 19, wherein the identification means is at least one of a barcode reader or a scale.

21. A checkout system in a store comprising the customer behavioural system according to claim 1.

22. A customer behavioural method for determining behavioural information of a customer in a store, the customer behavioural method comprising:
collecting sensor data comprising information relating to at least one motion event of the customer and/or at least one behavioural feature of the customer,
determining, based on the collected sensor data, at least one motion event of the customer and/or at least one behavioural feature of the customer, and
determining behavioural information of said customer based on the at least one motion event and/or at least one behavioural feature.

23. The method according to claim 22, further comprising the step of:
providing an output based on the determined behavioural information.

24. The method according to claim 23, wherein the output is arranged to provide guidance events for a customer, provide guidance events for store personnel and/or to provide statistical information to the customer behavioural system.

25. The method according to claim 22, wherein the steps of determining at least one motion event and at least one behavioural feature is performed using post-processing algorithms of the collected sensor data.

26. The method according to claim 25, wherein the post-processing algorithms is at least one of: machine learning, deep learning, convolutional neural networks, computer vision, human pose estimation, object detection, image classification, action classification and/or optical flow.
